(19) United States
(12) Patent Application Publication
(10) Pub. No.: US 2016/0161876 A1
(43) Pub. Date: Jun. 9, 2016

(54) MEMBER FOR ELECTROPHOTOGRAPHY AND METHOD FOR PRODUCING THE SAME

(71) Applicant: CANON KABUSHIKI KAISHA, Tokyo (JP)

(72) Inventors: Tomoya Uesugi, Susono-shi (JP); Minoru Ito, Susono-shi (JP); Kazuhito Wakabayashi, Mishima-shi (JP); Masaki Yamada, Mishima-shi (JP)

(21) Appl. No.: 14/954,435

(22) Filed: Nov. 30, 2015

(30) Foreign Application Priority Data
Dec. 3, 2014 (JP) 2014-245135

(51) Int. Cl. B05C 1/08; B05D 1/18; G03G 15/02

(52) U.S. Cl. CPC G03G 15/0233

(57) ABSTRACT

A member for electrophotography includes a base, an elastic layer on the base, the elastic layer comprising a silicone rubber, and a resin layer on the elastic layer and containing a resin. The resin in the resin layer and a silicon atom in the silicone rubber contained in the elastic layer bond to each other with a linking group. The linking group has a particular structure, and the linking group has a molecular weight of 58 or more and 550 or less.

### BACKGROUND OF THE INVENTION

1. Field of the Invention

The present disclosure relates to a member for electrophotography used as a developing member, a charging member, or the like and to a method for producing the member for electrophotography.

2. Description of the Related Art

In recent years, various characteristics have been required for electrophotographic apparatuses, and thus various functions have also been required for members for electrophotography (e.g., conductive rollers for electrophotography) such as developing members and charging members. For example, in the case of developing members that employ a contact developing method, it has been required in order to form stable images that the wear resistance for sliding members is improved while the drum nip is kept constant. In other words, the developing member needs to be softened to stabilize the drum nip while at the same time the surface of the developing member that contacts sliding members needs to be hardened to improve the wear resistance. Therefore, developing members often have a multilayer structure including an elastic layer and a resin layer. The elastic layer provides flexibility and the resin layer provides wear resistance. However, the recent realization of high-speed electrophotographic apparatuses increases the stress exerted to an interface between the elastic layer and the resin layer, which sometimes causes interlayer peeling at the interface between the elastic layer and the resin layer during the long-term use.

Japanese Patent Laid-Open No. 2009-138190 discloses an invention that aims to improve the interfacial strength between an elastic layer and a resin layer of a member for electrophotography. This is achieved by using a member for electrophotography that includes a silicone rubber elastic layer and a resin layer formed of an isocyanate compound, a coupling agent which reacts with the isocyanate compound, and an organic silane compound.

The present invention is directed to providing a member for electrophotography in which a sufficiently high adhesive strength is maintained at an interface between an elastic layer containing a silicone rubber and a resin layer, and a method for producing the member for electrophotography.

### SUMMARY OF THE INVENTION

In an aspect of the present disclosure, a member for electrophotography includes a base, an elastic layer on the base, the elastic layer comprising a silicone rubber, and a resin layer on the elastic layer, the resin layer containing a resin. The resin in the resin layer and a silicon atom in the silicone rubber contained in the elastic layer bond to each other with a linking group. The linking group has a molecular weight of 58 or more and 550 or less. The linking group comprises a structure represented by the structural formula selected from the group consisting of structural formulae (1), (2), and (3) below.

*-T1-Q1-O—** Structural formula (1)

*-T2-Q2-NHCO—** Structural formula (2)

*-T3-Q3-S—** Structural formula (3)

In the structural formulae (1) to (3), T1 to T3 each independently represent a divalent hydrocarbon group having 2 to 8 carbon atoms; Q1 to Q3 each independently represent a divalent organic group constituted by a carbon atom and a hydrogen atom or a divalent organic group constituted by a carbon atom, a hydrogen atom, and an oxygen atom; “*” represents a point of bonding with the silicon atom in the silicone rubber contained in the elastic layer; and “**” represents a point of bonding with the resin in the resin layer.

In another aspect of the present disclosure, a method for producing a member for electrophotography including a base, an elastic layer on the base, the elastic layer comprising a silicone rubber, and a resin layer on the elastic layer, the resin layer containing a urethane resin, includes the steps of:

providing a silicone rubber layer having a hydrosilyl group in a chemical structure and disposed on the base,

forming a layer on the silicone rubber layer, the layer containing an isocyanate compound, a polyol compound, and a compound having a vinyl group and a functional group that reacts with at least one of an isocyanate group in the isocyanate compound and a hydroxy group in the polyol compound; and

forming the elastic layer and the resin layer on the elastic layer by reacting the isocyanate compound and the polyol compound to form a urethane resin, reacting the functional group and at least one of the isocyanate group and the hydroxy group, and reacting the vinyl group and the hydrosilyl group in the silicone rubber layer.

In still another aspect of the present disclosure, a method for producing a member for electrophotography including a base, an elastic layer on the base, the elastic layer comprising a silicone rubber, and a resin layer on the elastic layer, the resin layer containing an epoxy resin, includes the steps of:

providing a silicone rubber layer having a hydrosilyl group in a chemical structure and disposed on the base,

forming a layer on the silicone rubber layer, the layer containing a compound having an epoxy group and a compound having a vinyl group and a functional group that reacts with the epoxy group; and

forming the elastic layer and the resin layer on the elastic layer by cleaving the epoxy group to form an epoxy resin, reacting the functional group and the epoxy group, and reacting the vinyl group and the hydrosilyl group in the silicone rubber layer.

Further features of the present disclosure will become apparent from the following description of exemplary embodiments with reference to the attached drawing.

### BRIEF DESCRIPTION OF THE DRAWINGS

FIG. 1A is a schematic sectional view of a member for electrophotography (a conductive roller for electrophotography) according to an embodiment of the present invention, the sectional view being taken in a direction parallel to an axial direction of a mandrel (base); and FIG. 1B is a schematic sectional view of the member for electrophotography, the sectional view being taken in a direction perpendicular to the axial direction.

### DESCRIPTION OF THE EMBODIMENTS

In members for electrophotography, an addition-curable silicone rubber is suitably used for forming an elastic layer which is disposed to stabilize the formation of nip with a contact member.

The elastic layer desirably has characteristics (hereafter, also referred to as “setting resistance”) in which after the elastic layer is in contact with other members for a long time, the contact portion is easily recovered from the deformed state.

According to studies conducted by the present inventors, in order to improve the setting resistance of the elastic layer formed of an addition-curable silicone rubber, it is effective to use, for the elastic layer, an addition-curable silicone rubber containing a polysiloxane component in an amount larger than that of a crosslinking component in which a hydrogen atom is directly bonded to a silicon atom. Such an addition-curable silicone rubber increases the hardness by self-reaction of the polysiloxane component and decreases the permanent deformation due to compression, and thus the setting resistance can be improved.

The present inventors have conducted studies on the member for electrophotography including a resin layer in Japanese Patent Laid-Open No. 2009-138190 by using an elastic layer formed of an addition-curable silicone rubber containing a larger amount of a polysiloxane component. As a result, they confirmed that the adhesive strength sometimes decreases at the interface between the elastic layer and the resin layer.

In the studies, the following material is used as the addition-curable silicone rubber containing a larger amount of the polysiloxane component. That is, a material prepared by mixing a liquid silicone rubber material 1 (trade name: SE6724A, manufactured by Dow Corning Toray Co., Ltd.) and a liquid silicone rubber material 2 (trade name: SE6724B, manufactured by Dow Corning Toray Co., Ltd.), which are also used in Examples described later, at a mass ratio of 45:55 is used.

As a result of studies on the member for electrophotography based on Japanese Patent Laid-Open No. 2009-138190, the reason for which the adhesive strength decreases at the interface between the elastic layer and the resin layer when the silicone rubber containing a larger amount of the polysiloxane component is used for the elastic layer may be as follows.

That is, it is believed that the elastic layer and the resin layer adhere to each other in Japanese Patent Laid-Open No. 2009-138190 because a vinyl group left in the silicone rubber elastic layer and an organic silane compound described in Japanese Patent Laid-Open No. 2009-138190 are chemically bonded to each other.

However, a sufficient amount of vinyl group is not left in the silicone rubber elastic layer containing a larger amount of the polysiloxane component. Therefore, it is believed that the elastic layer and the resin layer do not sufficiently adhere to each other. That is, when the silicone rubber containing a larger amount of the polysiloxane component is used for the elastic layer, a chemical bond is substantially not formed at the interface between the elastic layer and the resin layer and thus the adhesive strength decreases.

Accordingly, the present inventors have considered that, in order to cause the silicone rubber elastic layer containing a larger amount of the polysiloxane component and the resin layer to sufficiently adhere to each other at their interface, a hydrosilyl group left in the elastic layer and a resin contained in the resin layer are bonded to each other using a particular linking group.

As a result, the present inventors have found that a member for electrophotography that can achieve a sufficiently high interfacial strength between the silicone rubber elastic layer and the resin layer can be obtained. They also found that a high-quality electrophotographic image can be stably formed for a long time by using the member for electrophotography.

Embodiments of the present disclosure will be described in detail.

### Member for Electrophotography

A member for electrophotography according to an embodiment of the present invention includes a mandrel (base), an elastic layer disposed on the base, and a resin layer containing a resin (e.g., urethane resin and epoxy resin) and disposed on the elastic layer. The elastic layer is formed of a cured product of an addition-curable liquid silicone rubber mixture and contains a silicone rubber (cured product). The resin in the resin layer and a silicon atom in the silicone rubber contained in the elastic layer bond to each other with a particular linking group.

That is, in the member for electrophotography, a silicon atom in the silicone rubber contained in the elastic layer and the resin in the resin layer bond to each other with a linking group derived from a particular compound (linking compound) described below. The linking group has a structure represented by one structural formula selected from the group consisting of structural formulae (1) to (3) ((1), (2), and (3)) below, and the linking group has a molecular weight of 58 or more and 550 or less.

*-T1-Q1-O—** Structural formula (1)

*-T2-Q2-NHCO—** Structural formula (2)

*-T3-Q3-S—** Structural formula (3)

In the structural formulae (1) to (3), T1 to T3 (T1, T2, and T3) each independently represent a straight-chain or branched-chain divalent hydrocarbon group having 2 to 8 carbon atoms.

In the structural formulae (1) to (3), examples of the hydrocarbon group represented by T1 to T3 include straight-chain or branched-chain divalent saturated hydrocarbon groups. Specific examples thereof include C₂H₄ (e.g., straight chain: —C₂H₄— and branched chain: —CH(CH₃)—) and C₃H₆ (e.g., straight chain: —C₃H₆— and branched chain: —CH₂CH(CH₃)— and —C(CH₃)₂—).

In the structural formulae (1) to (3), “*” represents a point of bonding with a silicon atom in the silicone rubber contained in the elastic layer. The point of bonding is, for example, a bond derived from a reaction (hydrosilylation) of a vinyl group and a hydrosilyl group.

In the structural formulae (1) to (3), “**” represents a point of bonding with the resin in the resin layer. The point of bonding is, for example, a urethane bond, a bond derived from a reaction of a thiol group and an epoxy group, and a bond derived from a reaction of epoxy groups.

In the structural formulae, Q1 to Q3 each independently represent a divalent organic group constituted by a carbon atom and a hydrogen atom or a divalent organic group constituted by a carbon atom, a hydrogen atom, and an oxygen atom.

Q1 to Q3 each represent CₙHₘ (n and m each independently represent an integer of 1 or more) or CₚH_{q}Oᵣ (P, q, and r each independently represent an integer of 1 or more).

CₙHₘ and CₚH_{q}Oᵣ may have a straight chain or a branched chain.

*-T1, *-T2, *-T3, O—**, NHCO—**, or S—** may bond to a terminal atom (e.g., terminal carbon atom) of Q1 to Q3 or may bond to an atom (e.g., a carbon atom in a straight chain) other than the terminal atom of Q1 to Q3. For example, when Q1 represents C₃H₆ in the structural formula (1), the structural formula (1) may be a straight-chain T1-CH₂CH₂CH₂—O—** or a branched-chain *-T1-CH(C₂H₅)—O—**. Furthermore, although the reason is described later, Q1 to Q3 each desirably have at least one bond selected from an ether bond and an ester bond in the chemical structure thereof.

Furthermore, when Q1 to Q3 represent a structure selected from the group consisting of structures represented by structural formulae (A-1) and (A-2) below, better effects are produced.

That is, when Q1 to Q3 in the structural formulae (1) to (3) each represent a straight-chain or branched-chain hydrocarbon structure which has 2 to 4 carbon atoms and bonds to T1 to T3 with an ether bond or an ester bond or a hydrocarbon structure containing oxygen, better effects are produced.

—O—C_{X}H_{D}O_{M}— Structural formula (A-1)

—COO—C_{Y}H_{E}O_{N}— Structural formula (A-2)

In the structural formulae (A-1) and (A-2), X and Y each independently represent an integer of 2 or more and 4 or less, D and E each independently represent an integer of 2 or more and 8 or less, and M and N each independently represent an integer of 0 or more and 2 or less.

In the structural formulae (A-1) and (A-2), “−O” and “—COO” bond to any of T1 to T3 in the structural formulae (1) to (3), and “C_{X}H_{D}O_{M}—” and “C_{Y}H_{E}O_{N}—” bond to any of “O—**”, “NHCO—**”, and “S—**” in the structural formulae (1) to (3).

The member for electrophotography may have a suitable shape such as a roller-like shape or a belt-like shape. For example, the member for electrophotography can be used as a conductive roller such as a developing roller or a charging roller in an electrophotographic apparatus. Hereafter, the description will be made focusing on the conductive roller.

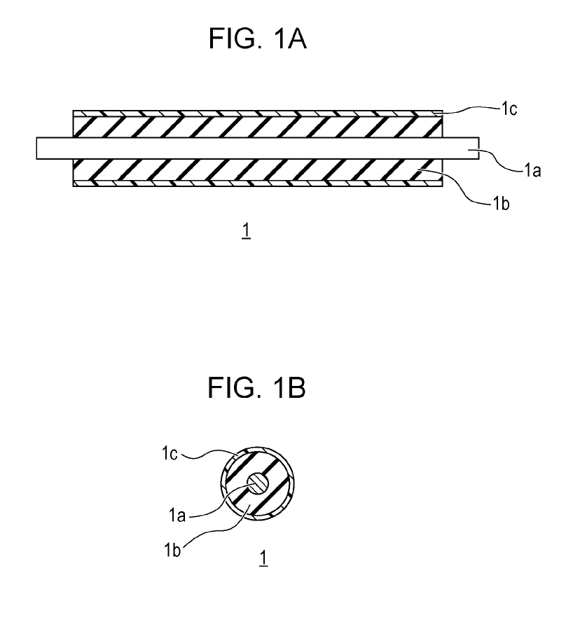

FIGS. 1A and 1B are schematic sectional views illustrating an example of a roller-shaped member for electrophotography (conductive roller for electrophotography) according to an embodiment of the present invention. FIG. 1A is a schematic sectional view of a conductive roller 1 for electrophotography taken in a direction parallel to the axial direction of a mandrel and FIG. 1B is a schematic sectional view of the conductive roller 1 for electrophotography taken in a direction perpendicular to the axial direction of the mandrel. The conductive roller 1 for electrophotography includes a mandrel 1a, an elastic layer 1b disposed on the outer periphery of the mandrel 1a, and a resin layer 1c disposed on the outer periphery of the elastic layer 1b.

The member for electrophotography may have another layer (e.g., adhesive layer (primer layer)) between the mandrel and the elastic layer (in FIGS. 1A and 1B, on the outer periphery of the mandrel 1a).

The member for electrophotography according to an embodiment of the present invention can be suitably used for process cartridges and electrophotographic apparatuses.

### Mandrel

The mandrel may be suitably selected from mandrels that function as an electrode and a supporting member of a conductive member. The mandrel may be made of a conductive material such as a conductive synthetic resin or a metal or an alloy, e.g., aluminum, copper, stainless steel, or iron. The shape of the mandrel may be suitably selected in accordance with the shape of the member for electrophotography. For example, the mandrel may have a shape such as a solid cylindrical shape or a belt-like shape.

### Elastic Layer

The elastic layer used in an environment of the present invention is a layer for providing elasticity that achieves a contact with another member at an appropriate area during the pressure contact. As long as this purpose is satisfied, the elastic layer may have a single-layer structure or a multilayer structure. However, a layer (first elastic layer) adjacent to the resin layer contains an addition-curable silicone rubber (cured product). The addition-curable liquid silicone rubber mixture, which is a coating liquid for forming a first elastic layer, may contain a conductive agent and other additives in addition to the addition-curable silicone rubber.

### First Elastic Layer

The first elastic layer is formed of a cured product of the addition-curable liquid silicone rubber mixture and contains a silicone rubber. The silicon atom in the silicone rubber contained in the first elastic layer bonds to a resin in the resin layer with a particular linking group as described above. In the state (curing may be performed) of a layer of the addition-curable liquid silicone rubber mixture (silicone rubber layer: precursor layer of first elastic layer) disposed on the mandrel, the first elastic layer may have a hydrosilyl group in its chemical structure. The hydrosilyl group and a group (e.g., isocyanate group, epoxy group, and hydroxy group) contained in the resin in the resin layer are linked to each other with a linking group derived from a particular compound (e.g., a compound having a vinyl group and a hydroxy group, a thiol group, an epoxy group, or an isocyanate group) that constitutes the resin layer. Thus, the first elastic layer and a resin layer described below can be formed.

Addition-Curable Silicone Rubber

In general, a raw material (hereafter also referred to as an “addition-curable silicone rubber composition”) for the addition-curable silicone rubber that forms the elastic layer contains

(a) an organopolysiloxane having an unsaturated aliphatic group,
(b) an organopolysiloxane containing an active hydrogen bonded to silicon, and
(c) a platinum compound serving as a crosslinking catalyst.

The organopolysiloxane (a) having an unsaturated aliphatic group is exemplified below:

a straight-chain organopolysiloxane whose molecular terminals are represented by R1₂R2SiO_{1/2} and whose intermediate units are represented by R1₂SiO and R1R2SiO, and

a branched organopolysiloxane whose molecular terminals are represented by R1₂R2SiO_{1/2} and which contains R1SiO_{3/2} and/or SiO_{4/2} as intermediate units.

Herein, R1 represents an unsubstituted or substituted monovalent hydrocarbon group which is bonded to a silicon atom and does not contain an unsaturated aliphatic group. Specific examples thereof include alkyl groups such as a methyl group, an ethyl group, a n-propyl group, a n-butyl group, a n-pentyl group, and a n-hexyl group; aryl groups such as a phenyl group and a naphthyl group; and substituted hydrocarbon groups such as a chloromethyl group, a 3-chloropropyl group, a 3,3,3-trifluoropropyl group, a 3-cyanopropyl group, and a 3-methoxypropyl group.

In terms of ease of synthesis and handling and good heat resistance, 50% or more of R1 represents a methyl group and, in particular, 100% of R1 represents a methyl group.

Furthermore, R2 represents an unsaturated aliphatic group bonded to a silicon atom. Examples of R2 include a vinyl group, an aryl group, a 3-butenyl group, a 4-pentenyl group, and a 5-hexenyl group. In particular, a vinyl group is used in terms of ease of synthesis and handling and promotion of a crosslinking reaction of the silicone rubber.

The organopolysiloxane (b) having an active hydrogen bonded to silicon is a crosslinking agent used for forming a crosslinked structure by a reaction with an alkenyl group of the organo polysiloxane component (a) having an unsaturated aliphatic group through catalysis of the platinum compound. In the organopolysiloxane (b) having an active hydrogen bonded to silicon, the number of hydrogen atoms bonded to silicon atoms is, for example, more than two in one molecule on average. The organic group bonded to a silicon atom is, for example, the same unsubstituted or substituted monovalent hydrocarbon group as R1 of the organo polysiloxane component having an unsaturated aliphatic group. In particular, a methyl group is used in terms of ease of synthesis and handling. The molecular weight of the organopolysiloxane having an active hydrogen bonded to silicon is not particularly limited.

The viscosity of the organopolysiloxane (b) having an active hydrogen bonded to silicon at 25° C. is preferably 200 cps or more and 150,000 cps or less and more preferably 500 cps or more and 50,000 cps or less. When the viscosity is 200 cps or more, the organopolysiloxane does not easily volatilize during the storage, and a desired degree of crosslinking and desired physical properties can be achieved in a silicone rubber to be obtained. Furthermore, when the viscosity is 150,000 cps or less, the organopolysiloxane can be easily handled and thus can be easily uniformly dispersed in a system.

The siloxane skeleton of the organopolysiloxane (b) having an active hydrogen bonded to silicon may be any of a straight-chain skeleton, a branched skeleton, and a cyclic skeleton or a mixture of the foregoing. In particular, a straight-chain skeleton is used in terms of ease of synthesis. In the organopolysiloxane (b) having an active hydrogen bonded to silicon, the Si—H bond may be present in any of siloxane units in the molecule, but at least part of the Si—H bond is, for example, present at the molecular terminal of the organopolysiloxane like the R1₂HSiO_{1/2} unit.

In the addition-curable silicone rubber composition, the organopolysiloxane (a) having an unsaturated aliphatic group and the organopolysiloxane (b) having an active hydrogen bonded to silicon are mixed so that the ratio of the number of unsaturated aliphatic groups to the number of silicon atoms is 0.001 or more and 0.08 or less and desirably 0.002 or more and 0.05 or less.

They are also mixed so that the ratio of the number of active hydrogens to the number of unsaturated aliphatic groups is, for example, 1.0 or more and 5.0 or less. When the ratio of the number of active hydrogens to the number of unsaturated aliphatic groups is 1.0 or more, a desired hardness can be stably achieved in the cured silicone rubber. When the ratio of the number of active hydrogens to the number of unsaturated aliphatic groups is 5.0 or less, an excess increase in the hardness of the silicone rubber can be suppressed. The ratio of the number of active hydrogens to the number of unsaturated aliphatic groups can be calculated by quantifying the number of unsaturated aliphatic groups and the number of active hydrogens through 1H-nuclear magnetic resonance (1H-NMR (trade name: AL400 FT-NMR, manufactured by JEOL Ltd.)).

The addition-curable silicone rubber is not particularly limited. An addition-curable silicone rubber containing a larger amount of polysiloxane component produces more significant effects of the present invention.

The solid content of the addition-curable silicone rubber in the first elastic layer (cured product of addition-curable liquid silicone rubber mixture) is, for example, 60.0 mass % or more in terms of setting resistance and 99.9 mass % or less in terms of conductivity.

Conductive Agent

The first elastic layer may contain a conductive agent in order to impart conductivity. The conductive agent added to the first elastic layer is, for example, carbon black, and the carbon black is not particularly limited. The carbon black is, for example, acetylene black or furnace black such as SAF, ISAF, HAF, MAF, FEF, GPF, or SRF.

The content of the carbon black in the first elastic layer is preferably 1 part by mass or more and 20 parts by mass or less and more preferably 2 parts by mass or more and 18 parts by mass or less based on the mass (100 parts by mass) of the rubber component in the first elastic layer in terms of conductivity. These conductive agents may be used alone or in combination of two or more.

The first elastic layer may also optionally contain another conductive agent in addition to the carbon black. Examples of the other conductive agent include graphite; conductive metals and alloys such as aluminum, copper, tin, and stainless steel; and metal oxides, such as tin oxide, zinc oxide, indium oxide, titanium oxide, and tin oxide-antimony oxide solid solutions, subjected to a conducting treatment.

The content of the other conductive agent in the first elastic layer is preferably 2 parts by mass or more and 20 parts by mass or less and more preferably 5 parts by mass or more and 18 parts by mass or less based on the mass (100 parts by mass) of the rubber component in the first elastic layer in terms of conductivity. The other conductive agents may be used alone or in combination of two or more.

The first elastic layer may also contain an ionic conductive agent other than the conductive agent described above. Examples of the ionic conductive agent include quaternary ammonium salts such as perchlorates, chlorates, fluoroborates, sulfates, ethosulfates, and benzyl halides (e.g., benzyl bromides and benzyl chlorides) of lauryltrimethylammonium, stearyltrimethylammonium, octadodecyltrimethylammonium, dodecyltrimethylammonium, hexadecyltrimethylammonium, and modified fatty acid-dimethylethylammonium; and aliphatic sulfonates, higher alcohol sulfates, higher alcohol ethylene oxide added sulfates, higher alcohol phosphates, higher alcohol ethylene oxide added phosphates, betaines, higher alcohol ethylene oxides, polyethylene glycol fatty acid esters, and polyhydric alcohol fatty acid esters.

The content of the ionic conductive agent in the first elastic layer is preferably 0.01 parts by mass or more and 5 parts by mass or less and more preferably 0.1 parts by mass or more and 3 parts by mass or less based on the mass (100 parts by mass) of the rubber component in the first elastic layer in terms of conductivity. These ionic conductive agents may be used alone or in combination of two or more.

Other Additives

Other additives publicly known in the field of conductive rollers for electrophotographic apparatuses may be contained in the first elastic layer. For example, a reinforcing agent such as hydrophilic silica, hydrophobic silica, quartz, calcium carbonate, aluminum oxide, zinc oxide, or titanium oxide may be optionally added to the first elastic layer.

### Other Elastic Layers

In the case where a plurality of elastic layers are disposed on the mandrel, elastic layers publicly known in the field of conductive rollers for electrophotography may be used as elastic layers other than the first elastic layer as long as the above-described purpose is achieved. The other elastic layers may contain the conductive agent, the other additives, and the like at the above-described mixing ratios as in the case of the first elastic layer. The first elastic layer and the other elastic layers may have the same composition or different compositions.

### Resin Layer

The resin layer contains a resin (e.g., a urethane resin and an epoxy resin).

The resin layer is disposed on the elastic layer (first elastic layer) containing a silicone rubber. The resin layer can be formed by curing a coating liquid which contains a compound (hereafter referred to as a “linking compound”) that chemically bonds to a silicon atom in the silicone rubber and a raw material (resin raw material) that forms the resin layer and which contains a raw material for a resin (e.g., a urethane resin and an epoxy resin). That is, the resin layer is a cured product of the coating liquid. The coating liquid may optionally contain a conductive agent, roughening particles for imparting roughness, and a solvent (e.g., methyl ethyl ketone).

### Linking Compound

The linking compound can improve the adhesiveness between the resin layer and the elastic layer containing a silicone rubber. The linking compound has both a functional group (e.g., a vinyl group) that bonds to a silyl group (e.g., a hydrosilyl group) left in the silicone rubber layer, which is a precursor layer of the elastic layer, and a functional group (e.g., an isocyanate group, a hydroxy group, an epoxy group, and a thiol group) that bonds to a resin forming the resin layer. The linking compounds may be used alone or in combination of two or more.

The linking compound for forming the above-described linking group is a compound based on the type of resin used for the resin layer. For example, when a urethane resin is used for the resin layer, the following linking compound can be used. That is, a compound having a functional group that reacts with a polyol compound (hydroxy group) or an isocyanate compound (isocyanate group), which is a raw material for the urethane resin, and a functional group (e.g., a vinyl group) that reacts with a silicon atom (hydrosilyl group) in the silicone rubber is used as the linking compound. Specifically, a compound having a vinyl group and at least one of an isocyanate group and a hydroxy group can be used as the linking compound.

For example, when an epoxy resin is used for the resin layer, the following linking compound can be used. That is, a compound having a functional group that reacts with an epoxy compound (epoxy group), which is a raw material for an epoxy resin, and a functional group (e.g., a vinyl group) that reacts with a silicon atom (hydrosilyl group) in the silicone rubber is used as the linking compound. Specifically, a compound having a vinyl group and at least one of an epoxy group and a thiol group can be used as the linking compound.

When the linking compound has a low molecular weight, the adhesiveness between the elastic layer and the resin layer further improves. In other words, the linking compound having a low molecular weight easily permeates the silicone rubber layer and thus easily reacts with a hydrosilyl group in the silicone rubber layer. Consequently, the adhesiveness between the elastic layer and the resin layer further improves. In an embodiment of the present invention, when the molecular weight of a moiety derived from the linking compound after the reaction (the molecular weight of the linking group that chemically bonds the elastic layer and the resin portion) is 58 or more and 550 or less, the adhesiveness between the elastic layer and the resin layer improves. In terms of the reactivity with a hydrosilyl group in the silicone rubber layer, the number of carbon atoms of a moiety in the linking compound that reacts with a hydrosilyl group needs to be 8 or less. Specifically, in four functional groups that bond to the vinyl group, the total number of carbon atoms of the vinyl group and all functional groups except for a functional group that bonds to the resin needs to be 8 or less. That is, T1 to T3 in the structural formulae (1) to (3) each independently represent a straight-chain or branched-chain divalent hydrocarbon group having 2 to 8 carbon atoms.

When the linking compound has a polar structure except for the functional groups that bond to the elastic layer and the resin portion, the adhesiveness between the elastic layer and the resin layer further improves. The linking compound having a polar structure easily permeates the silicone rubber layer and thus easily reacts with a hydrosilyl group in the silicone rubber layer. Consequently, the adhesiveness between the elastic layer and the resin layer further improves. In an embodiment of the present invention, Q1, Q2, or Q3 has, for example, at least one selected from an ether bond and an ester bond. Such a bond produces the above-described effects, which further improves the adhesiveness between the elastic layer and the resin layer.

Furthermore, when Q1 to Q3 in the structural formulae (1) to (3) each represent a straight-chain or branched-chain hydrocarbon structure which has 2 to 4 carbon atoms and bonds to T1 to T3 with an ether bond or an ester bond or a hydrocarbon structure containing oxygen, better effects are produced. The reason for this may be as follows. The linking compound has an ether bond or an ester bond, which is a polar group, adjacent to the vinyl group that reacts with a hydrosilyl group in the silicone rubber layer. In addition, the hydrocarbon moiety or the hydrocarbon moiety containing oxygen in Q1 to Q3 has 2 to 4 carbon atoms and thus the steric hindrance is relatively small.

Therefore, the linking compound easily permeates the silicone rubber layer and easily reacts with the hydrosilyl group in the silicone rubber layer.

### Resin Raw Material

The resin raw material is the same as described above. For example, when the resin layer contains a urethane resin, a polyol compound and an isocyanate compound can be used. When the resin layer contains an epoxy resin, an epoxy compound can be used.

Polyol Compound

Examples of the polyol compound include divalent polyol compounds (diols) such as ethylene glycol, diethylene glycol, propylene glycol, dipropylene glycol, 1,4-butanediol, hexanediol, neopentyl glycol, 1,4-cyclohexanediol, 1,4-cyclohexanedimethanol, xylene glycol, and triethylene glycol; trivalent or higher-valent polyol compounds such as 1,1,1-trimethylolpropane, glycerin, pentaerythritol, and sorbitol; and high-molecular-weight polyol compounds such as polyethylene glycol, polypropylene glycol, and ethylene oxide-propylene oxide block glycols obtained by adding ethylene oxide and propylene oxide to diols and triols. These polyol compounds may be used alone or in combination of two or more.

Isocyanate Compound

Examples of the isocyanate compound include diphenylmethane-4,4′-diisocyanate, 1,5-naphthalene diisocyanate, 3,3′-dimethylbiphenyl-4,4′-diisocyanate, 4,4′-dicyclohexylmethane diisocyanate, p-phenylene diisocyanate, isophorone diisocyanate, carbodiimide-modified MDI, xylylene diisocyanate, trimethylhexamethylene diisocyanate, tolylene diisocyanate, naphthylene diisocyanate, p-phenylene diisocyanate, hexamethylene diisocyanate, and polymethylenepolyphenyl polyisocyanate. These isocyanate compounds may be used alone or in combination of two or more.

Epoxy Compound

The epoxy compound may be any of glycidyl-ether, glycidyl-ester, glycidyl-amine, and alicyclic epoxy compounds. Specific examples of the epoxy compound include aromatic bifunctional compounds such as a bisphenol A epoxy compound, a bisphenol F epoxy compound, a brominated bisphenol A epoxy compound, a hydrogenated bisphenol A epoxy compound, a bisphenol S epoxy compound, a bisphenol AF epoxy compound, a biphenyl epoxy compound, a naphthalene epoxy compound, and a fluorene epoxy compound; aliphatic bifunctional compounds such as an ethylene glycol epoxy compound; and polyfunctional epoxy compounds such as a phenol novolac epoxy compound, an o-cresol novolac epoxy compound, a DPP novolac epoxy compound, a tris(hydroxyphenyl)methane epoxy compound, and a tetraphenylolethane epoxy compound. These epoxy compounds may be used alone or in combination of two or more.

### Conductive Agent

The resin layer may contain a conductive agent in order to impart conductivity. Examples of the conductive agent added to the resin layer include carbon black, and conductive agents and ionic conductive agents used together with carbon black.

Carbon Black

The carbon black is not particularly limited. For example, the above-described carbon black that can be used for the first elastic layer can also be used. The content of the carbon black in the resin layer is preferably 1 part by mass or more and 80 parts by mass or less and more preferably 10 parts by mass or more and 30 parts by mass or less based on the mass (100 parts by mass) of the resin component in the resin layer in terms of conductivity. They may be used alone or in combination of two or more.

Another Conductive Agent

The resin layer may also optionally contain another conductive agent together with carbon black. For example, the above-described other conductive agent that can be used for the first elastic layer can be used. The content of the other conductive agent in the resin layer is preferably 2 parts by mass or more and 30 parts by mass or less and more preferably 5 parts by mass or more and 20 parts by mass or less based on the mass (100 parts by mass) of the resin component in the resin layer in terms of conductivity. They may be used alone or in combination of two or more.

The resin layer may also contain an ionic conductive agent other than the conductive agent. For example, the above-described ionic conductive agent that can be used for the first elastic layer can also be used. The content of the ionic conductive agent in the resin layer is preferably 0.01 parts by mass or more and 10 parts by mass or less and more preferably 0.5 parts by mass or more and 5 parts by mass or less based on the mass (100 parts by mass) of the resin component in the resin layer in terms of conductivity. They may be used alone or in combination of two or more.

### Roughening Particle

The resin layer may also contain roughening particles in order to impart roughness. The roughening particles are not particularly limited, and resin particles such as acrylic resin particles, silicone resin particles, urethane resin particles, or phenolic resin particles can be used. They may be used alone or in combination of two or more.

### Method for Producing Member for Electrophotography

The member for electrophotography can be produced by a production method including the following steps:

1) a step of forming a silicone rubber layer on a mandrel (base), the silicone rubber layer having a hydrosilyl group in the chemical structure;

2) a step of forming a layer on the silicone rubber layer, the layer containing a resin raw material and a compound (linking compound) having a functional group that reacts with a functional group in the resin raw material and a functional group that reacts with the hydrosilyl group; and

3) a step of forming an elastic layer (first elastic layer) and a resin layer on the elastic layer (first elastic layer) by reacting the resin raw material, the linking compound, and the functional group in the silicone rubber layer.

The production method may also include a step of providing a mandrel, a step of forming another layer (e.g., a primer layer) on the mandrel (between the mandrel and the elastic layer), and a step of forming an elastic layer (an elastic layer other than the first elastic layer) on the mandrel (between the mandrel and the silicone rubber layer). Each of the steps will be described below.

### Step 1

A method publicly known in the field of conductive rollers for electrophotography can be employed as the production method for forming a silicone rubber layer (precursor layer of first elastic layer) on a mandrel. For example, a method in which both a mandrel and a material for forming an elastic layer (addition-curable silicone rubber mixture) are extruded is employed. Alternatively, if the material for forming an elastic layer (addition-curable silicone rubber mixture) is liquid, a method in which a material for forming an elastic layer is injected into a die including a cylindrical pipe, plugs disposed at both ends of the pipe for holding a mandrel, and a mandrel and then heat-cured is employed.

The same method can also be applied when an elastic layer other than the first elastic layer is formed on the mandrel.

### Steps 2 and 3

Subsequently, a layer (precursor layer of resin layer) containing a raw material for forming a resin layer (a resin raw material and a linking compound, and optionally a conductive agent and roughening particles) is formed on the silicone rubber layer formed on the mandrel, and cured while heating is performed when necessary. Thus, an elastic layer and a resin layer are formed.

To form the resin layer, a coating liquid containing these raw materials can be used. The coating liquid can be prepared by dispersing the raw material for forming a resin layer in a solvent. The dispersion method and the dispersion time can be suitably set in accordance with the purpose of the member for electrophotography (conductive roller for electrophotography) to be produced.

The coating method for a resin layer is not particularly limited, and the resin layer can be formed by a wet coating process such as dip coating, spray coating, roll coating, or ring coating.

For example, when the resin layer is formed by dip coating, the elastic layer and the resin layer can be formed by the following method. That is, the silicone rubber layer (elastic member) formed on the mandrel is immersed in the coating liquid containing a resin raw material, a linking compound, and a solvent and optionally a conductive agent and roughening particles, and then heat curing is performed. Thus, the first elastic layer and the resin layer can be formed. In this method, if necessary, the viscosity of the coating liquid may be adjusted and the coating liquid may be circulated.

Although the heat curing conditions are dependent on the raw materials used, the reaction can be generally caused to proceed at 80° C. or higher in terms of curing properties. The reaction can be caused to proceed at 180° C. or lower to prevent the resin component from decomposing. The heating time is, for example, 5 hours or less in terms of the decomposition of the resin component.

When a urethane resin is used as a resin in the resin layer, an isocyanate compound and a polyol compound can be used as the resin raw material. A compound having a vinyl group and a functional group that reacts with at least one of an isocyanate group of the isocyanate compound and a hydroxy group of the polyol compound can be used as the linking compound. Through the curing treatment, the isocyanate compound and the polyol compound in the precursor layer of the resin layer are reacted with each other to form a urethane resin while at the same time the functional group in the linking compound and at least one of the isocyanate group and the hydroxy group are reacted with each other and the vinyl group in the linking compound and the hydrosilyl group in the silicone rubber layer are reacted with each other. Thus, a first elastic layer and a resin layer formed on the elastic layer can be obtained.

When an epoxy resin is used as a resin in the resin layer, a compound having an epoxy group (epoxy compound) can be used as the resin raw material. A compound having a vinyl group and a functional group that reacts with the epoxy group can be used as the linking compound. Through the curing treatment, the epoxy group in the precursor layer of the resin layer is cleaved to from an epoxy resin while at the same time the functional group in the linking compound and the epoxy group are reacted with each other and the vinyl group in the linking compound and the hydrosilyl group in the silicone rubber layer are reacted with each other. Thus, a first elastic layer and a resin layer formed on the elastic layer can be obtained.

According to an embodiment of the present invention, there can be provided a member for electrophotography in which the interfacial strength between an elastic layer containing a silicone rubber and a resin layer is improved and thus a sufficiently high adhesive strength is maintained, and a method for producing the member for electrophotography.

### EXAMPLES

The present invention will be further described in detail below based on Examples, but is not limited thereto. Production of member (conductive roller) for electrophotography

### Preparation of Mandrel 1

First, a mandrel 1 was prepared by applying a primer (trade name: DY35-051, manufactured by Dow Corning Toray Co., Ltd.) onto a metal core having a diameter of 6 mm and made of SUS304 (stainless steel 304) and performing baking.

### Production of Silicone Rubber Layer 1

The prepared mandrel 1 was set in a die. An addition-curable silicone rubber composition prepared by mixing the following materials was injected into a cavity in the die. The die was heated and the silicone rubber was cured by performing vulcanization at 150° C. for 15 minutes.

Liquid silicone rubber material 1 (trade name: SE6724A, manufactured by Dow Corning Toray Co., Ltd.): 45 parts by mass

Liquid silicone rubber material 2 (trade name: SE6724B, manufactured by Dow Corning Toray Co., Ltd.): 55 parts by mass

Carbon black (trade name: TOKABLACK #4300, manufactured by TOKAI CARBON Co., Ltd.): 15 parts by mass

Silica powder for imparting heat resistance: 0.2 parts by mass

Platinum catalyst: 0.1 parts by mass

The mandrel having a peripheral surface on which the cured silicone rubber layer was formed was released from the die. Then, the mandrel was further heated at 180° C. for 1 hour to complete the curing reaction of the silicone rubber layer. Thus, an elastic roller 1 in which a silicone rubber layer 1 having a diameter of 12 mm was formed on the peripheral surface of the mandrel 1 was produced.

### Preparation of Coating Liquid for Forming Resin Layer

### Preparation of Linking Compound

### Preparation of Linking Compounds 1 to 10, 14 to 26, and 28 to 32

Commercially available products listed in Tables 1 and 2 were used as linking compounds 1 to 10, 14 to 26, and 28 to 32.

### Preparation of Linking Compounds 11 to 13 and 27

The linking compounds 11 to 13 and 27 were prepared by the following methods.

### Preparation of Linking Compound 11 (Compound 1 Having Vinyl Group and Hydroxy Group)

A compound A was prepared in the same manner as in Example 3 of Japanese Patent Laid-Open No. 2013-166829, except that the amount of azobisisobutyronitrile (AIBN) was changed to 0.15 mol and the reaction time was changed to 12 hours. The molecular weight of the compound A, which was analyzed by pyrolysis gas chromatography, was 234. Herein, PYROFOIL SAMPLER JPS-700 (trade name) manufactured by Japan Analytical Industry Co., Ltd. was used as a pyrolyzer, and Trace GCMS (trade name) manufactured by Thermo Fisher Scientific K.K. was used as a gas chromatography-mass spectrometer.

Subsequently, the compound A was heat-treated at 140° C. for 1 hour using concentrated sulfuric acid to obtain a linking compound 11. The molecular weight of the linking compound 11, which was analyzed by pyrolysis gas chromatography, was 216. Therefore, the structure of the linking compound 11 was identified as listed in Table 1. Preparation of linking compound 12 (compound 2 having vinyl group and hydroxy group)

A compound B was prepared in the same manner as in the compound A, except that the amount of AIBN was changed to 0.13 mol. The molecular weight of the compound B, which was analyzed by pyrolysis gas chromatography, was 350. Subsequently, the compound B was heat-treated at 140° C. for 1 hour using concentrated sulfuric acid to obtain a linking compound 12. The molecular weight of the linking compound 12, which was analyzed by pyrolysis gas chromatography, was 332. Therefore, the structure of the linking compound 12 was identified as listed in Table 1.

### Preparation of Linking Compound 13 (Compound 3 Having Vinyl Group and Hydroxy Group)

A compound C was prepared in the same manner as in the compound A, except that the amount of AIBN was changed to 0.10 mol. The molecular weight of the compound C, which was analyzed by pyrolysis gas chromatography, was 582. Subsequently, the compound C was heat-treated at 140° C. for 1 hour using concentrated sulfuric acid to obtain a linking compound 13. The molecular weight of the linking compound 13, which was analyzed by pyrolysis gas chromatography, was 546. Therefore, the structure of the linking compound 13 was identified as listed in Table 1.

### Preparation of Linking Compound 27 (Compound 4 Having Vinyl Group and Hydroxy Group)

A compound D was prepared in the same manner as in the compound A, except that the amount of AIBN was changed to 0.08 mol. The molecular weight of the compound D, which was analyzed by pyrolysis gas chromatography, was 698. Subsequently, the compound D was heat-treated at 140° C. for 1 hour using concentrated sulfuric acid to obtain a linking compound 27. The molecular weight of the linking compound 27, which was analyzed by pyrolysis gas chromatography, was 662. Therefore, the structure of the linking compound 27 was identified as listed in Table 2.

TABLE 1

| Linking | |
|---|---|
| com- | |
| pound | |
| No. | Name/Structural formula |
| 1 | Allyl alcohol (Showa Chemical Industry Co., Ltd.) |
| | Structural formula: CH₂═CHCH₂—OH |
| 2 | 1-Penten-3-ol (Tokyo Chemical Industry Co., Ltd.) |
| | Structural formula: CH₂═CHCH(OH)CH₂CH₃ |
| 3 | 2-Hydroxyethyl vinyl ether (NIPPON CARBIDE INDUSTRIES |
| | Co., Inc.) |
| | Structural formula: CH₂═CHO(CH₂)₂—OH |
| 4 | 5-Hexen-1-ol (Tokyo Chemical Industry Co., Ltd.) |
| | Structural formula: CH₂═CH(CH₂)₄—OH |
| 5 | 5-Hexenoic acid (Tokyo Chemical Industry Co., Ltd.) |
| | Structural formula: CH₂═CH(CH₂)₃—COOH |
| 6 | 4-Hydroxybutyl vinyl ether (Wako Pure Chemical Industries, |
| | Ltd.) |
| | Structural formula: CH₂═CHO(CH₂)₄—OH |
| 7 | 2-Hydroxyethyl acrylate (Tokyo Chemical Industry Co., Ltd.) |
| | Structural formula: CH₂═CHCOO(CH₂)₂—OH |
| 8 | 2-Isocyanatoethyl acrylate (Tokyo Chemical Industry Co., Ltd.) |
| | Structural formula: CH₂═CHCOO(CH₂)₂—NCO |
| 9 | 4-Hydroxybutyl acrylate (Tokyo Chemical Industry Co., Ltd.) |
| | Structural formula: CH₂═CHCOO(CH₂)₄—OH |
| 10 | 2-Isocyanatoethyl 2-methylpropenoate (Tokyo Chemical |
| | Industry Co., Ltd.) |
| | Structural formula: CH₂═C(CH₃)COO(CH₂)₂—NCO |
| 11 | Compound 1 having vinyl group and hydroxy group |
| | Structural formula: |
| | 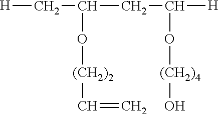 |
| 12 | Compound 2 having vinyl group and hydroxy group |
| | Structural formula: |
| | 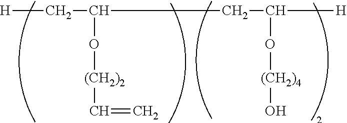 |
| 13 | Compound 3 having vinyl group and hydroxy group |
| | Structural formula: |
| | 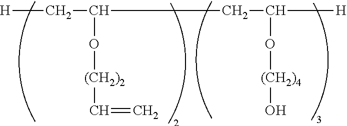 |
| 14 | 3-Decenoic acid |
| | Structural formula: CH₃(CH₂)₅CH═CHCH₂—COOH |
| 15 | Allyl mercaptan (Tokyo Chemical Industry Co., Ltd.) |
| | Structural formula: CH₂═CHCH₂—SH |
| 16 | 3-Methyl-2-butene-1-thiol (Tokyo Chemical Industry Co., Ltd.) |
| | Structural formula: (CH₃)₂C═CHCH₂—SH |
| 17 | 3,4-Epoxy-1-butene (Tokyo Chemical Industry Co., Ltd.) |
| | Structural formula: |
| | 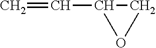 |

TABLE 2

| Linking | |
|---|---|
| compound | |
| No. | Name/Structural formula |
| 18 | 1,2-Epoxy-5-hexene (Tokyo Chemical Industry Co., Ltd.) |
| | Structural formula: |
| | 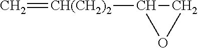 |
| 19 | Allyl glycidyl ether (Tokyo Chemical Industry Co., Ltd.) |
| | Structural formula: |
| | 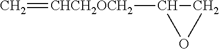 |
| 20 | Glycidyl methacrylate (Tokyo Chemical Industry Co., Ltd.) |
| | Structural formula: |
| | 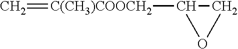 |
| 21 | 1,2-Epoxy-9-decene (Tokyo Chemical Industry Co., Ltd.) |
| | Structural formula: |
| | 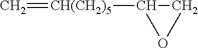 |
| 22 | n-Heptane (Tokyo Chemical Industry Co., Ltd.) |
| | Structural formula: CH₃(CH₂)₅CH₃ |
| 23 | 1-Heptene (Tokyo Chemical Industry Co., Ltd.) |
| | Structural formula: CH₂═CH(CH₂)₄CH₃ |
| 24 | 1-Heptanol (Tokyo Chemical Industry Co., Ltd.) |
| | Structural formula: CH₃(CH₂)₅CH₂—OH |
| 25 | 2-Ethylhexyl vinyl ether (Tokyo Chemical Industry Co., Ltd.) |
| | Structural formula: CH₂═CHOCH₂CH(C₂H₅)(CH₂)₃CH₃ |
| 26 | Ethylene glycol monohexyl ether (Tokyo Chemical Industry |
| | Co., Ltd.) |
| | Structural formula: CH₃(CH₂)₅O(CH₂)₂—OH |
| 27 | Compound 4 having vinyl group and hydroxy group |
| | Structural formula: |
| | 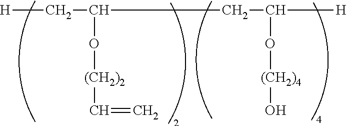 |
| 28 | n-Hexane (Tokyo Chemical Industry Co., Ltd.) |
| | Structural formula: CH₃(CH₂)₄CH₃ |
| 29 | 1-Hexene (Tokyo Chemical Industry Co., Ltd.) |
| | Structural formula: CH₂═CH(CH₂)₃CH₃ |
| 30 | 1-Hexanethiol (Tokyo Chemical Industry Co., Ltd.) |
| | Structural formula: CH₃(CH₂)₄CH₂—SH |
| 31 | Ethyl mercaptoacetate (Tokyo Chemical Industry Co., Ltd.) |
| | Structural formula: CH₃CH₂OCOCH₂—SH |
| 32 | 2-Dodecenol (Tokyo Chemical Industry Co., Ltd.) |
| | Structural formula: CH₃(CH₂)₈CH═CH—CH₂OH |

### Preparation of Coating Liquid for Resin Layer

### Preparation of Coating Liquids 1 to 23

Materials (linking compound, resin component, conductive agent, roughening particles, and methyl ethyl ketone (MEK) serving as a solvent) listed in Table 3 below were stirred with a stirring motor and then mixed with a sand mill. Subsequently, MEK serving as a solvent was further added thereto to adjust the viscosity. Thus, coating liquids 1 to 23 were prepared. Table 3 shows the total amount (parts by mass) of the solvent (MEK) used to prepare each of the coating liquids.

TABLE 3

| Coating | Linking | | Resin component | | | | | | | | | |
|---|---|---|---|---|---|---|---|---|---|---|---|---|
| liquid | compound | | Polyol compound | | Isocyanate compound | | Conductive agent | | Roughening particle | | Solvent | |
| No. | No. | Part | Trade name | Part | Trade name | Part | Trade name | Part | Trade name | Part | Trade name | Part |
| 1 | 1 | 20 | TAKELAC | 100 | CORONATE | 90 | MA-100 | 25 | C-400 Clear | 40 | MEK | 160 |
| 2 | 2 | parts | TE5060 | parts | 2521 | parts | (manufactured | parts | (manufactured | parts | (manufactured | parts |
| 3 | 3 | by mass | (manufactured | by | (manufactured | by | by | by | by | by | by | by |
| 4 | 4 | | by | mass | by | mass | Mitsubishi | mass | Negami | mass | KISHIDA | mass |
| 5 | 5 | | Mitsui | | Nippon | | Chemical | | Chemical | | CHEMICAL | |
| 6 | 6 | | Chemical | | Polyurethane | | Corporation) | | Industrial Co., | | Co., Ltd.) | |
| 7 | 7 | | Industrial Co., | | Industry Co., | | | | Ltd.) | | | |
| 8 | 8 | | Ltd.) | | Ltd.) | | | | | | | |
| 9 | 9 | | | | | | | | | | | |
| 10 | 10 | | | | | | | | | | | |
| 11 | 11 | | | | | | | | | | | |
| 12 | 12 | | | | | | | | | | | |
| 13 | 13 | | | | | | | | | | | |
| 14 | 14 | | | | | | | | | | | |
| 15 | 6 | 10 | | | | | | | | | | |
| | | parts | | | | | | | | | | |
| | | by | | | | | | | | | | |
| | | mass | | | | | | | | | | |
| | 9 | 10 | | | | | | | | | | |
| | | parts | | | | | | | | | | |
| | | by | | | | | | | | | | |
| | | mass | | | | | | | | | | |
| 16 | 8 | 10 | | | | | | | | | | |
| | | parts | | | | | | | | | | |
| | | by | | | | | | | | | | |
| | | mass | | | | | | | | | | |
| | 10 | 10 | | | | | | | | | | |
| | | parts | | | | | | | | | | |
| | | by | | | | | | | | | | |
| | | mass | | | | | | | | | | |
| 17 | None- | | | | | | | | | | | |
| 18 | 22 | 20 | | | | | | | | | | |
| 19 | 23 | parts | | | | | | | | | | |
| 20 | 24 | by | | | | | | | | | | |
| 21 | 25 | mass | | | | | | | | | | |
| 22 | 26 | | | | | | | | | | | |
| 23 | 27 | | | | | | | | | | | |

### Preparation of Coating Liquids 24 to 39

Materials (linking compound, resin component, conductive agent, roughening particles, and MEK serving as a solvent) listed in Table 4 below were stirred with a stirring motor and then mixed with a sand mill.

Subsequently, MEK serving as a solvent was further added thereto to adjust the viscosity. Thus, coating liquids 24 to 39 were prepared. Table 4 shows the total amount (parts by mass) of the solvent (MEK) used to prepare each of the coating liquids.

TABLE 4

| Coating | Linking | | Resin component | | | | | | | | | |
|---|---|---|---|---|---|---|---|---|---|---|---|---|
| liquid | compound | | Epoxy compound | | Curing agent | | Conductive agent | | Roughening particle | | Solvent | |
| No. | No. | Part | Trade name | Part | Trade name | Part | Trade name | Part | Trade name | Part | Trade name | Part |
| 24 | 15 | 20 | jER | 100 | jER Cure | 150 | MA-100 | 25 | C-400 Clear | 40 | MEK | 160 |
| 25 | 16 | parts | 1001B80 | parts | ST11 | parts | (manu- | parts | (manu- | parts | (manu- | parts |
| 26 | 17 | by | (manu- | by | (manu- | by | factured | by | factured | by | factured | by |
| 27 | 18 | mass | factured | mass | factured | mass | by | mass | by | mass | by | mass |
| 28 | 19 | | by | | by | | Mitsubishi | | Negami | | KISHIDA | |
| 29 | 20 | | Mitsubishi | | Mitsubishi | | Chemical | | Chemical | | CHEMICAL | |
| 30 | 21 | | Chemical | | Chemical | | Corporation) | | Industrial Co., | | Co., | |
| 31 | 15 | 10 | Corporation) | | Corporation) | | | | Ltd.) | | Ltd.) | |
| | | parts | | | | | | | | | | |
| | | by | | | | | | | | | | |
| | | mass | | | | | | | | | | |
| | 16 | 10 | | | | | | | | | | |
| | | parts | | | | | | | | | | |
| | | by | | | | | | | | | | |
| | | mass | | | | | | | | | | |
| 32 | 17 | 10 | | | | | | | | | | |
| | | parts | | | | | | | | | | |
| | | by | | | | | | | | | | |
| | | mass | | | | | | | | | | |
| | 21 | 10 | | | | | | | | | | |
| | | parts | | | | | | | | | | |
| | | by | | | | | | | | | | |
| | | mass | | | | | | | | | | |
| 33 | — | | | | | | | | | | | |
| 34 | 25 | 20 | | | | | | | | | | |
| 35 | 28 | parts | | | | | | | | | | |
| 36 | 29 | by | | | | | | | | | | |
| 37 | 30 | mass | | | | | | | | | | |
| 38 | 31 | | | | | | | | | | | |
| 39 | 32 | | | | | | | | | | | |

### Example 1

The elastic roller 1 was immersed in the coating liquid 1 listed in Table 3 and then heat-cured at 90° C. for 5 hours to obtain a conductive roller 1 of Example 1.

### Evaluation of Adhesiveness Between Elastic Layer and Resin Layer

The obtained conductive roller 1 was evaluated in terms of adhesiveness by performing delamination between the elastic layer (first elastic layer) and the resin layer and observing the fracture surface on the elastic layer. Specifically, the conductive roller 1 was left to stand in an environment of 40° C./95% RH for 2 months (2 months in total), further left to stand for 4 months (6 months in total), and further left to stand for 6 months (12 months in total). These conductive rollers were left to stand in an environment of 23° C./50% RH for one day. Subsequently, a peeling test was performed on each of the conductive rollers in the same environment of 23° C./50% RH in conformity with JIS K 6854-2. The adhesiveness between the elastic layer and the resin layer was evaluated based on the criteria shown in Table 5. Table 6 shows the evaluation results.

TABLE 5

| Evaluation of | |
|---|---|
| adhesiveness | Fracture surface on elastic layer (first elastic layer) |
| A | The surface of the elastic layer is not exposed on the |
| | entire fracture surface. |
| B | The surface of the elastic layer is exposed on part of the |
| | fracture surface. |
| C | The surface of the elastic layer is exposed on the entire |
| | fracture surface. |

### Examples 2 to 16

Conductive rollers 2 to 16 were produced in the same manner as in Example 1, except that the coating liquid was changed to the coating liquids 2 to 16 listed in Table 3. Table 6 shows the evaluation results of the adhesiveness of the produced conductive rollers 2 to 16.

### Example 17

The elastic roller 1 was immersed in the coating liquid 24 listed in Table 4 and then left to stand at 23° C. for 24 hours. Subsequently, the elastic roller 1 was heat-cured at 65° C. for 3 hours and then further heat-cured at 90° C. for 5 minutes to produce a conductive roller 17. Table 6 shows the evaluation results of the adhesiveness of the produced conductive roller 17.

### Examples 18 to 25

Conductive rollers 18 to 25 were produced in the same manner as in Example 17, except that the coating liquid was changed to the coating liquids 25 to 32 listed in Table 4. Table 6 shows the evaluation results of the adhesiveness of the produced conductive rollers 18 to 25.

TABLE 6

| | Conductive | Coating liquid | Linking compound | | Linking group | | Evaluation of adhesiveness | | |
|---|---|---|---|---|---|---|---|---|---|
| Example | roller | No. | No. | Polar structure | Structure | Molecular weight | 2 months | 6 months | 12 months |
| 1 | 1 | 1 | 1 | None | Structure (1) | 58 | A | B | B |
| 2 | 2 | 2 | 2 | None | | 86 | A | B | B |
| 3 | 3 | 3 | 3 | Ether structure | | 88 | A | A | A |
| 4 | 4 | 4 | 4 | None | | 100 | A | B | B |
| 5 | 5 | 5 | 5 | None | | 114 | A | B | B |
| 6 | 6 | 6 | 6 | Ether structure | | 116 | A | A | A |
| 7 | 7 | 7 | 7 | Ester structure | | 116 | A | A | A |
| 8 | 8 | 8 | 8 | Ester structure | Structure (2) | 141 | A | A | A |
| 9 | 9 | 9 | 9 | Ester structure | Structure (1) | 144 | A | A | A |
| 10 | 10 | 10 | 10 | Ester structure | Structure (2) | 155 | A | A | A |
| 11 | 11 | 11 | 11 | Ether structure | Structure (1) | 216 | A | A | B |
| 12 | 12 | 12 | 12 | Ether structure | | 332 | A | A | B |
| 13 | 13 | 13 | 13 | Ether structure | | 546 | A | A | B |
| 14 | 14 | 14 | 14 | None | | 170 | A | B | B |
| 15 | 15 | 15 | 6, 9 | Ether structure | | 116 | A | A | A |
| | | | | Ester structure | | 144 | | | |
| 16 | 16 | 16 | 8, 10 | Ester structure | Structure (2) | 141 | A | A | A |
| | | | | | | 155 | | | |
| 17 | 17 | 24 | 15 | None | Structure (3) | 74 | A | B | B |
| 18 | 18 | 25 | 16 | None | | 102 | A | B | B |
| 19 | 19 | 26 | 17 | None | Structure (1) | 72 | A | B | B |
| 20 | 20 | 27 | 18 | None | | 100 | A | B | B |
| 21 | 21 | 28 | 19 | Ether structure | | 116 | A | A | B |
| 22 | 22 | 29 | 20 | Ester structure | | 144 | A | A | A |
| 23 | 23 | 30 | 21 | None | | 156 | A | B | B |
| 24 | 24 | 31 | 15, 16 | None | Structure (3) | 74 | A | B | B |
| | | | | | | 102 | | | |
| 25 | 25 | 32 | 17, 21 | None | Structure (1) | 72 | A | B | B |
| | | | | | | 156 | | | |

In the evaluation of adhesiveness in Table 6, good results were obtained in Examples 1 to 25. This is because, in Examples 1 to 25, a structure represented by any one of the structural formulae (1) to (3) was employed, and a bond derived from a linking group having a molecular weight of 58 or more and 550 or less was formed between the resin in the resin layer and the silicon atom in the elastic layer by the linking compounds 1 to 21.

In the evaluation of adhesiveness after 6 months, the evaluation results in Examples 3, 6 to 13, 15, 16, 21, and 22 were better than those in other Examples. This is because the linking compounds 3, 6 to 13, 19, and 20 intramolecularly have at least one polar structure selected from an ether structure and an ester structure. In other words, the linking compound intramolecularly having a polar structure easily permeates the silicone rubber layer, which further improves the adhesiveness between the elastic layer and the resin layer.

In the evaluation of adhesiveness after 12 months, particularly good results were obtained in Examples 3, 6 to 10, 15, 16, and 22. The reason for this may be as follows. The linking compounds 3, 6 to 10, and 20 have an ether bond or an ester bond, which is a polar group, adjacent to the vinyl group that reacts with a hydrosilyl group in the silicone rubber layer. In addition, the hydrocarbon moiety in Q1 to Q3 has 2 to 4 carbon atoms and thus the steric hindrance is relatively small. Therefore, the linking compound easily permeates the silicone rubber layer and easily reacts with the hydrosilyl group in the silicone rubber layer.

### Comparative Examples 1 to 7

Conductive rollers 26 to 32 were produced in the same manner as in Example 1, except that the coating liquid was changed to the coating liquids 17 to 23 listed in Table 3. Table 7 shows the evaluation results of the adhesiveness of the produced conductive rollers 26 to 32.

### Comparative Examples 8 to 14

Conductive rollers 33 to 39 were produced in the same manner as in Example 17, except that the coating liquid was changed to the coating liquids 33 to 39 listed in Table 4. Table 7 shows the evaluation results of the adhesiveness of the produced conductive rollers 33 to 39.

TABLE 7

| Comparative | Conductive | Coating | Linking compound | | Evaluation of adhesiveness | | |
|---|---|---|---|---|---|---|---|
| Example | roller | liquid No. | No. | Polar structure | 2 months | 6 months | 12 months |
| 1 | 26 | 17 | — | — | C | C | C |
| 2 | 27 | 18 | 22 | — | C | C | C |
| 3 | 28 | 19 | 23 | — | C | C | C |
| 4 | 29 | 20 | 24 | — | C | C | C |
| 5 | 30 | 21 | 25 | Ether structure | C | C | C |
| 6 | 31 | 22 | 26 | Ether structure | C | C | C |
| 7 | 32 | 23 | 27 | Ether structure | C | C | C |
| 8 | 33 | 33 | — | — | C | C | C |
| 9 | 34 | 34 | 25 | Ether structure | C | C | C |
| 10 | 35 | 35 | 28 | — | C | C | C |
| 11 | 36 | 36 | 29 | — | C | C | C |
| 12 | 37 | 37 | 30 | — | C | C | C |
| 13 | 38 | 38 | 31 | Ester structure | C | C | C |
| 14 | 39 | 39 | 32 | — | C | C | C |

In the evaluation of adhesiveness in Table 7, good results were not obtained in Comparative Examples 1 to 14. This is because the elastic layer (first elastic layer) and the resin layer do not chemically bond to each other. Hereafter, the reason for which the elastic layer and the resin layer do not chemically bond to each other will be described.

In Comparative Examples 1 and 8, the linking compound is not used, and thus the elastic layer and the resin layer do not chemically bond to each other.

In Comparative Examples 2 and 10, the linking compounds used do not have either a functional group that bonds to a silyl group left in the silicone rubber layer or a functional group that bonds to a resin forming the resin layer. Therefore, the elastic layer and the resin layer do not chemically bond to each other.

In Comparative Examples 3, 5, 9, and 11, the linking compounds used have a functional group that bonds to a silyl group left in the silicone rubber layer, but do not have a functional group that bonds to a resin forming the resin layer. Therefore, the elastic layer and the resin layer do not chemically bond to each other.

In Comparative Examples 4, 6, 12, and 13, the linking compounds used have a functional group that bonds to a resin forming the resin layer, but do not have a functional group that bonds to a silyl group left in the silicone rubber layer. Therefore, the elastic layer and the resin layer do not chemically bond to each other.

In Comparative Example 7, the linking compound used has both a functional group that reacts with a silyl group left in the silicone rubber layer and a functional group that reacts with a resin forming the resin layer, but has a high molecular weight. Thus, the linking compound does not easily permeate the silicone rubber layer. As a result, the linking compound does not react with a hydrosilyl group in the silicone rubber layer, and the elastic layer and the resin layer do not chemically bond to each other.

In Comparative Example 14, the linking compound used has both a functional group that reacts with a silyl group left in the silicone rubber layer and a functional group that reacts with a resin forming the resin layer, but the number of carbon atoms derived from a vinyl group is large. This causes steric hindrance and prevents the reaction with a silyl group. As a result, the elastic layer and the resin layer do not chemically bond to each other.

Accordingly, in Comparative Examples 1 to 14, the adhesiveness between the elastic layer and the resin layer cannot be improved for the reasons described above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-245135, filed Dec. 3, 2014, which is hereby incorporated by reference herein in its entirety.

What is claimed is:

1. A member for electrophotography comprising:
a base;
an elastic layer on the base, the elastic layer comprising a silicone rubber; and
a resin layer on the elastic layer, the resin layer comprising a resin,
wherein:
the resin in the resin layer and a silicon atom in the silicone rubber contained in the elastic layer bond to each other with a linking group,
the linking group has a molecular weight of 58 or more and 550 or less, and
the linking group has a structure represented by a structural formula selected from the group consisting of structural formulae (1), (2), and (3) below:
*-T1-Q1-O—** Structural formula (1)
*-T2-Q2-NHCO—** Structural formula (2)
*-T3-Q3-S—** Structural formula (3)
where T1 to T3 each independently represent a divalent hydrocarbon group having 2 to 8 carbon atoms,
Q1 to Q3 each independently represent a divalent organic group constituted by a carbon atom and a hydrogen atom or a divalent organic group constituted by a carbon atom, a hydrogen atom, and an oxygen atom,
“*” represents a point of bonding with the silicon atom in the silicone rubber contained in the elastic layer, and
“**” represents a point of bonding with the resin in the resin layer.

2. The member for electrophotography according to claim 1, wherein the elastic layer comprises a cured product of an addition-curable liquid silicone rubber mixture.

3. The member for electrophotography according to claim 1, wherein in the structural formula of the linking group, Q1, Q2, or Q3 has at least one bond selected from an ether bond and an ester bond.

4. The member for electrophotography according to claim 1, wherein in the structural formulae (1) to (3), Q1 to Q3 each independently represent a structure selected from structures represented by structural formulae (A-1) and (A-2) below:
—O—C_{X}H_{D}O_{M}— Structural formula (A-1)
—COO—C_{Y}H_{E}O_{N}— Structural formula (A-2)
where X and Y each independently represent an integer of 2 or more and 4 or less,
D and E each independently represent an integer of 2 or more and 8 or less,
M and N each independently represent an integer of 0 or more and 2 or less,
“—O” and “—COO” bond to any one of T1 to T3 in the structural formulae (1) to (3), and
“C_{X}H_{D}O_{M}—” and “C_{Y}H_{E}O_{N}—” bond to any one of “O—**”, “NHCO—**”, and “S—**” in the structural formulae (1) to (3).

5. A method for producing a member for electrophotography comprising a base, an elastic layer on the base, the elastic layer being made of a cured product of an addition-curable liquid silicone rubber mixture comprising a silicone rubber, and
a resin layer on the elastic layer, the resin layer comprising a urethane resin, the method comprising the steps of:
providing a silicone rubber layer having a hydrosilyl group in a chemical structure and disposed on the base,
forming a layer on the silicone rubber layer, the layer comprising an isocyanate compound, a polyol compound, and a compound having a vinyl group and a functional group that reacts with at least one of an isocyanate group in the isocyanate compound and a hydroxy group in the polyol compound; and
forming the elastic layer and the resin layer on the elastic layer by reacting the isocyanate compound and the polyol compound to form a urethane resin, reacting the functional group and at least one of the isocyanate group and the hydroxy group, and reacting the vinyl group and the hydrosilyl group in the silicone rubber layer.

6. A method for producing a member for electrophotography comprising a base, an elastic layer on the base, the elastic layer being made of a cured product of an addition-curable liquid silicone rubber mixture comprising a silicone rubber, and
a resin layer on the elastic layer, the resin layer comprising an epoxy resin, the method comprising the steps of:
providing a silicone rubber layer having a hydrosilyl group in a chemical structure and disposed on the base,
forming a layer on the silicone rubber layer, the layer comprising a compound having an epoxy group and a compound having a vinyl group and a functional group that reacts with the epoxy group; and
forming the elastic layer and the resin layer on the elastic layer by cleaving the epoxy group to form an epoxy resin, reacting the functional group and the epoxy group, and reacting the vinyl group and the hydrosilyl group in the silicone rubber layer.
